(19) United States
(12) Patent Application Publication
(10) Pub. No.: US 2003/0126323 A1
(43) Pub. Date: Jul. 3, 2003

(54) Solution for integrating a KVM extension transmitter with a graphics controller on an add-in card

(75) Inventors: Patrick L. Ferguson, Cypress, TX (US); Jeffrey C. Stevens, Spring, TX (US)

Correspondence Address: AKIN, GUMP, STRAUSS, HAUER & FELD, L.L.P., 300 WEST 6TH STREET, SUITE 2100, AUSTIN, TX, 78701, US

(73) Assignee: Compaq Information Technologies Group, L.P., Houston, TX

(21) Appl. No.: 10/035,778

(22) Filed: Dec. 31, 2001

(51) Int. Cl. G06F 13/12

(52) U.S. Cl. 710/63

(57) ABSTRACT

A computer interface extension configuration that includes a host having a motherboard, an extension transmitter card, and an extension receiver. The motherboard includes a first connector that allows motherboard signals to be shared internal to the host, and a second connector separate from the first connector that supports communications with the host. The extension transmitter card is positioned within the host and is electrically connected to the motherboard of the host via at least the first connector and the second connector. The extension transmitter card has a graphics controller that interfaces with the second connector independent from communications that occur on the first connector. The extension receiver is connected to a plurality of user interface devices and extensibly connected to the extension transmitter card. The extension receiver, among other things, receives data transmissions from the extension transmitter card of the host to thereby provide the data transmissions to one or more of the plurality of user interface devices.

### CROSS-REFERENCE TO RELATED APPLICATIONS

The present application is related to the following U.S. applications filed concurrently herewith: U.S. application Ser. ______ No. entitled “Method Of Connecting To A KVM Transmitter Using Internal Cables” by Ferguson et al. (Attorney Docket No. P01-3861); U.S. application Ser. No. ______ entitled “Method of Supporting Audio For KVM Extension In A Server Platform” by Ferguson et al. (Attorney Docket No. P01-3862); and U.S. application Ser. No. ______ entitled “Defining A PCI Function Or USB Endpoint For A KVM Extension Device For Enumeration, Manageability, And Security” by Ferguson (Attorney Docket No. P01-3863).

### BACKGROUND OF THE INVENTION

Standard computer interfaces such as keyboard, mouse, video, and audio are often referred to as KVM (“keyboard, video, mouse”) products. “KVM extension” can be defined as extending the access points for computer user interfaces such as keyboards, mice, monitors, etc., i.e., user interfaces may operate with a host processor although positioned outside the standard operating range for the user interface products. KVM extension products are particularly useful when dealing with rack mounted computer solutions where the computers of the rack are positioned away from the user interface products. However, among other things, today's rack mounted solutions suffer from excessive cabling issues when KVM extension products are introduced.

Fundamental components of computer interface extension solutions include KVM products, an extension receiver, an extension transmitter, and a host system. The extension solutions are commonly known as “KVM” (keyboard, video, mouse) extensions. A typical example for use of KVM extension solutions are remote trading solutions, i.e., when stock traders desire to perform remote trading without being required to accommodate a large number of host computer systems under their desk on the trading floor. The three major components used in remote trading solutions are a manageability switch, a transmitter/receiver pair, and a multi system switch. Each of these components are modular and can be used alone or in any combination. The KVM extension mode of operation typically supports user I/O protocols, sometimes referred to as “legacy” protocols, such as PS/2, analog video, and serial.

Many other problems and disadvantages of the prior art will become apparent to one skilled in the art after comparing such prior art with the present invention as described herein.

### BRIEF SUMMARY OF THE INVENTION

Various aspects of the present invention are realized through a computer interface extension configuration that includes a host having a motherboard, an extension transmitter card, and an extension receiver. The motherboard includes a first connector that allows motherboard signals to be shared internal to the host, and a second connector separate from the first connector that supports communications with the host. The extension transmitter card is positioned within the host and is electrically connected to the motherboard of the host via at least the first connector and the second connector. The extension transmitter card has a graphics controller that interfaces with the second connector independent from communications that occur on the first connector. The extension receiver is connected to a plurality of user interface devices and extensibly connected to the extension transmitter card. The extension receiver, among other things, receives data transmissions from the extension transmitter card of the host to thereby provide the data transmissions to one or more of the plurality of user interface devices.

The extension transmitter card of the computer interface extension configuration may include a peripheral connection interface (PCI) graphics controller that communicates with the motherboard independent of communications on the first connector. Alternatively, the extension transmitter card may include an accelerated graphics port (AGP) controller that communicates with the motherboard independent of communications on the first connector. The plurality of user interface devices are typically devices such as a keyboard, a mouse, a video monitor, a speaker, a serial link, a USB link, a power button, and a microphone. The extension receiver may be extensibly connected to the extension transmitter via a fiber optic cable or via a cable compatible with any version of category five or above type cables. One option for electrically connecting the extension transmitter card to the first connector of the motherboard of the host is via a ribbon cable connector disposed between the motherboard and the extension transmitter card. The extension transmitter card may be electrically connected to the second connector of the motherboard of the host via one of a PCI, PCI-X, or AGP interface.

Other aspects of the present invention may be realized with a computer interface extension transmitter that is configured from a host computer system having a motherboard with at least a first connector and a second connector that is separate from the first connector. An extension transmitter card is connected to the second connector of the motherboard. The extension transmitter card has a graphics controller and a motherboard header. The motherboard header is electrically connected to the first connector of the host computer system, and the graphics controller of the extension transmitter card defines an interface for communications between the extension transmitter card and the second connector of the host. An extension receiver is connected to the extension transmitter card and to at least one user interface device.

In one embodiment, the second connector of the computer interface extension transmitter is electrically connected to the extension transmitter card of the motherboard and operates according to a graphics communication standard taken from the group consisting of a PCI interface, a PCI-X interface, and an AGP interface. The first connector may be placed on the motherboard separately from the second connector and include audio communications with the extension receiver that pass through the extension transmitter card. Passing through the extension transmitter card from the extension receiver could be analog video communications with the extension receiver and digital video communications with the extension receiver. Also, in some embodiments, the graphics controller of the extension transmitter card is PCI compatible while in other embodiments the graphics controller of the extension transmitter card is AGP compatible.

Still other aspects of the present invention may be realized through a method for extending computer interface communications between a host computer and a plurality of computer interface devices. The method involves, not necessarily in this order: electrically connecting an extension transmitter card to a slot in the host computer system, the extension transmitter card having a graphics controller compatible with the slot in the host computer; enumerating the extension transmitter card with the host computer system such that the extension transmitter card is recognized by the host; electrically connecting a motherboard header of the extension transmitter card to a connector on the host that is separate from the slot in the host with which the extension transmitter card is electrically connected; and transmitting communications from the extension transmitter card to an extension receiver to complete operations with at least one of the plurality of computer interface devices.

Variations of the method include transmitting communications from the extension transmitter card by transmitting PCI compatible graphics communications, or transmitting communications from the extension transmitter card by transmitting AGP compatible graphics communications. Of course, other variations exist according to principles of the present invention.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a block diagram of a basic computer interface extension solution according to principles of the present invention.

FIG. 2 is a block diagram of another basic computer interface extension solution wherein a manageability switch is introduced into the solution.

FIG. 3 is a block diagram of a computer interface extension solution wherein a manageability switch and multi-system switches are introduced into the solution.

FIG. 4 is a simplified diagram of a motherboard having an add-in card that allows communications with the motherboard according to principles of the present invention.

FIG. 5 is a block diagram of one configuration for the add-in card of FIG. 4.

FIG. 6 is a block diagram of a second configuration for the add-in card of FIG. 4.

FIG. 7 is a block diagram of a third configuration for the add-in card of FIG. 4.

FIG. 8 is a block diagram of a host computer system motherboard configuration according to principles of the present invention.

### DETAILED DESCRIPTION OF THE INVENTION

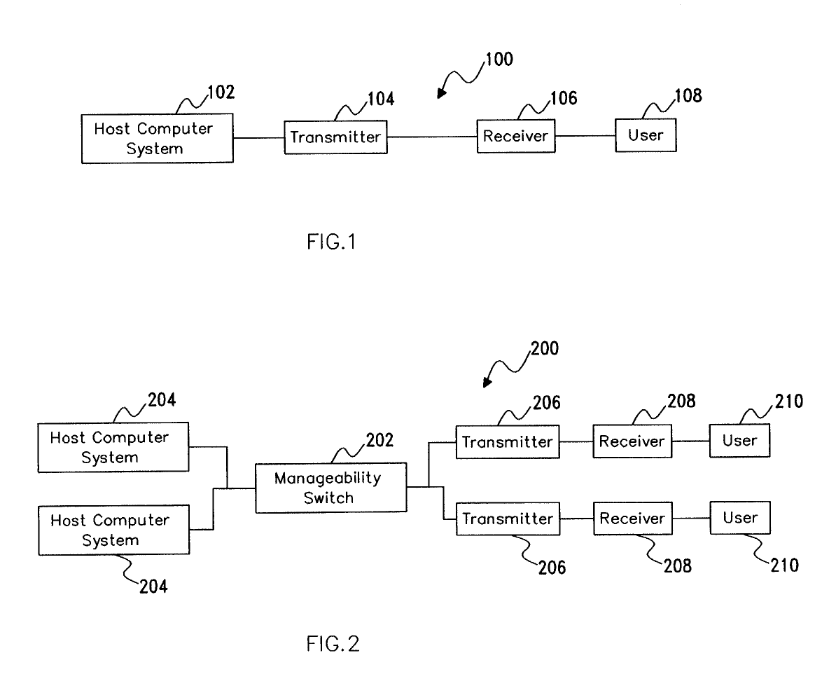

FIG. 1 is a block diagram of a basic computer interface extension solution 100 according to principles of the present invention. The solution 100 is illustrated as having a host computer system 102 with an extension transmitter 104 (herein referred to as “transmitter”). The transmitter 104 is connected to the extension receiver 106 (herein referred to as “receiver”) which is connected to a user 108. The user 108 is representative of standard user interface products such as a keyboard, mouse, monitor, serial port, audio devices, USB ports, etc. The solution 100 is commonly implemented as a KVM extension, however, as will be understood when viewing the description of the invention, the solution 100 may include more than KVM extension capabilities. Further, although data travels bi-directionally between the host computer system 102 and the user 108, to delineate the separation, the transmitter 104 and the receiver 106 are labeled as though data transfer occurs only in one direction, i.e., from the host computer system 102 to the user 108.

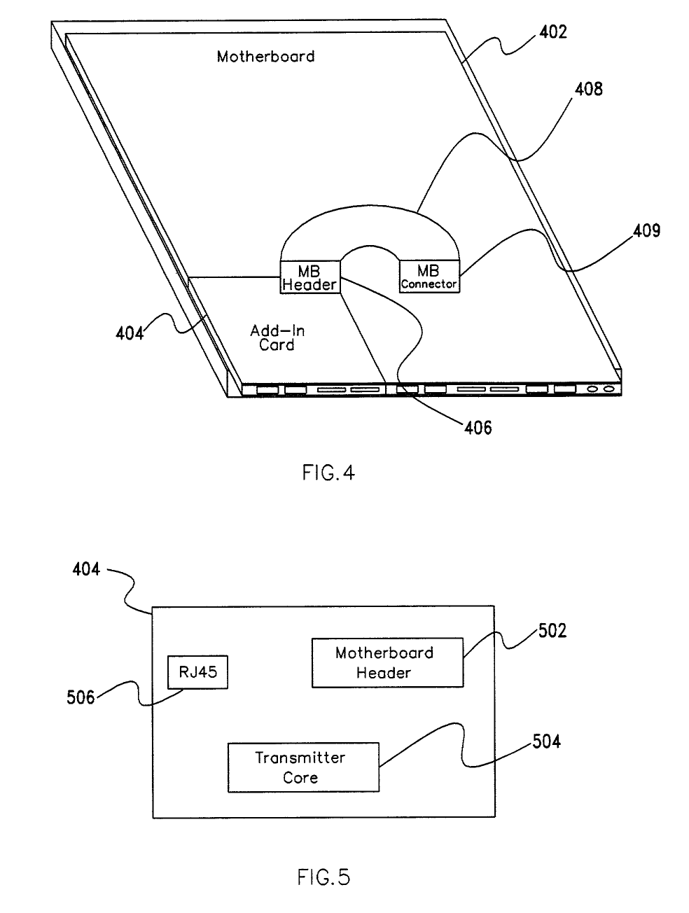

The transmitter 104 and receiver 106 are connected with a single cable such as a cable compatible with all versions of category 5, 6, 7, or better cables. The connection could also be made with fiber optic or other type of high speed data transmission cabling. The distance between the transmitter 104 and receiver 106 ranges approximately 300 meters. In this manner are the user interface devices of the user 108 allowed to communicate effectively with the host computer system 102 across long distances, “long” as compared to user/host communication distances in a system without the transmitter 104/receiver 106 pair. Although illustrated external to the host 102, the transmitter 104 may be positioned internal to the host computer system 102 and use an internal connector with the motherboard of the system 102 (see FIG. 4).

FIG. 2 is a block diagram of another basic computer interface extension solution 200 wherein a manageability switch 202 is introduced into the solution. The solution 200 includes multiple host computer systems 204, multiple transmitters 206, and multiple receivers 208 that support the communication extension for multiple users 210. The manageability switch 202 encompasses technology used to map a specific user to a specific system, to converge a large number of systems to a small number of users for system administration or head trader access, and to share a single system between two or more users.

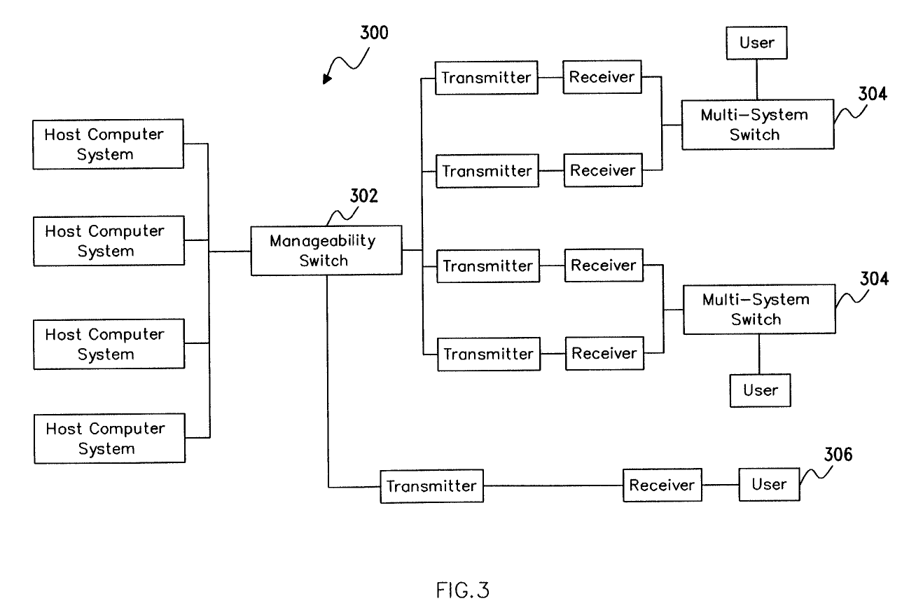

FIG. 3 is a block diagram of a computer interface extension solution 300 wherein a manageability switch 302 and multi-system switches 304 are introduced into the solution 300. An administrative user 306 is also illustrated that provides the capability to monitor the users 304 and make adjustments to the solution 300 configuration if necessary.

FIG. 4 is a simplified diagram of a motherboard 402 having an add-in card 404 that allows communications with the motherboard 402 according to principles of the present invention. The add-in card 404 is configured to operate as a transmitter in an extension solution such as a KVM extension solution. However, the add-in card 404 is not limited to KVM connections, but allows for power button, USB, and other connection types. Motherboard (MB) header 406, when connected by a cable 408 such as a ribbon cable to MB connector 409, allows the motherboard 402 to communicate directly with the add-in card 404 rather than only through an external connection between the motherboard 402 and the add-in card 404. This configuration eliminates the need for additional cables to be added externally to the host to communicate between the motherboard 402 and the add-in card 404, which is particularly desirable when the motherboard 402 is one of many motherboards in a rack mounted computer system.

As illustrated in the following figures, the add-in card 404 has various configurations for operation as a transmitter card.

FIG. 5 is a block diagram of one configuration for the add-in card 404. The add-in card 404 is configured with minimal circuitry components such that the motherboard performs most functions of the computer system. A motherboard header 502 acts as the primary interface with the motherboard and the functionality data of the motherboard is passed to a transmitter core 504 via the motherboard header 502 where the data is configured to be transmitted at a connector such as RJ-45 connector 506. Motherboard functionality data that is passed directly to the add-in card 404 commonly includes functions such as PS/2 mouse, PS/2 keyboard, USB 1.1 or 2.0, power button, card power, cable detect, analog video, digital video, analog audio, and RS-232 serial.

All functions can be included or excluded in the cable 408 definition as needed. For example, when RS-232 serial, digital and analog video, and audio functions are included in the functions, switching should occur on the motherboard to avoid conflicts and select between functional connectors on the motherboard and the add-in card 404. The add-in card 404 of FIG. 5 is considered to be a “dumb” card because the functionality is realized on the motherboard and passed to the add-in card 404 across the cable 408.

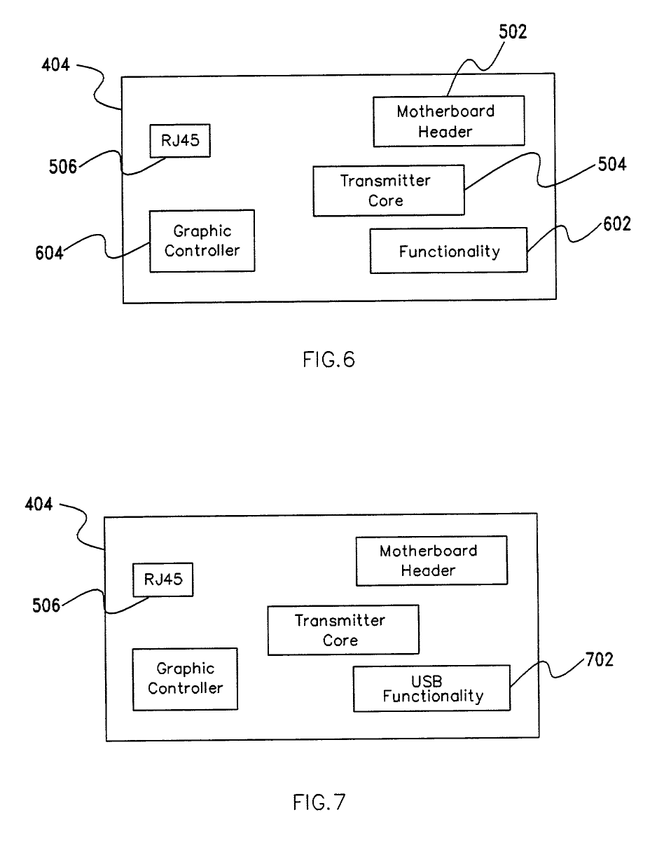

FIG. 6 is a block diagram of a second configuration for the add-in card 404. This configuration introduces functionality from the motherboard represented by functionality 602. The functionality 602 is flexible in that various degrees of motherboard functionality may be realized on the add-in card 404 itself, rather than on the motherboard and then transferred to the add-in card 404. In addition, a graphic controller 604 is included on the add-in card 404 for at least the reason that a slot may be opened on the motherboard. The graphic controller 604 may be compatible with PCI, AGP, or other protocol. For example, if the graphic controller 604 is PCI compatible, the add-in card 404 would be considered a PCI card and would plug into an available PCI slot while using the motherboard header 504 to communicate with other motherboard functionality that is not included in the functionality 602. Thus, an internal transmitter can be incorporated onto the motherboard without giving up an additional PCI slot on the motherboard. One type of functionality is supported when USB communications are converted to a PS/2-legacy type of protocol that is recognized by the extension receiver as the data is passed from the RJ-45 connector 506 of the transmitter add-in card 404.

FIG. 7 is a block diagram of a third configuration for the add-in card 404. A USB functionality component 702 is introduced such that the add-in card 404 operates using a USB protocol and transmits data from the RJ-45 connector 506 in a USB format. In one embodiment, the USB communications are extended by adding a USB hub that receives pure USB data and transmits raw data onto the extension where the receiver converts the signals back into USB format.

Of course, the USB functionality component 702 is exemplary of the different types of functions that may be implemented on the add-in card 404 rather than on the motherboard. For example, the functionality could include audio in/out signals and serial RS-232 protocols. One additional possibility is that the functionality 702 could include the capability to allow the computer system to recognize that the add-in card 404 is present in a computer thereby enabling enumeration of such add-in card 404.

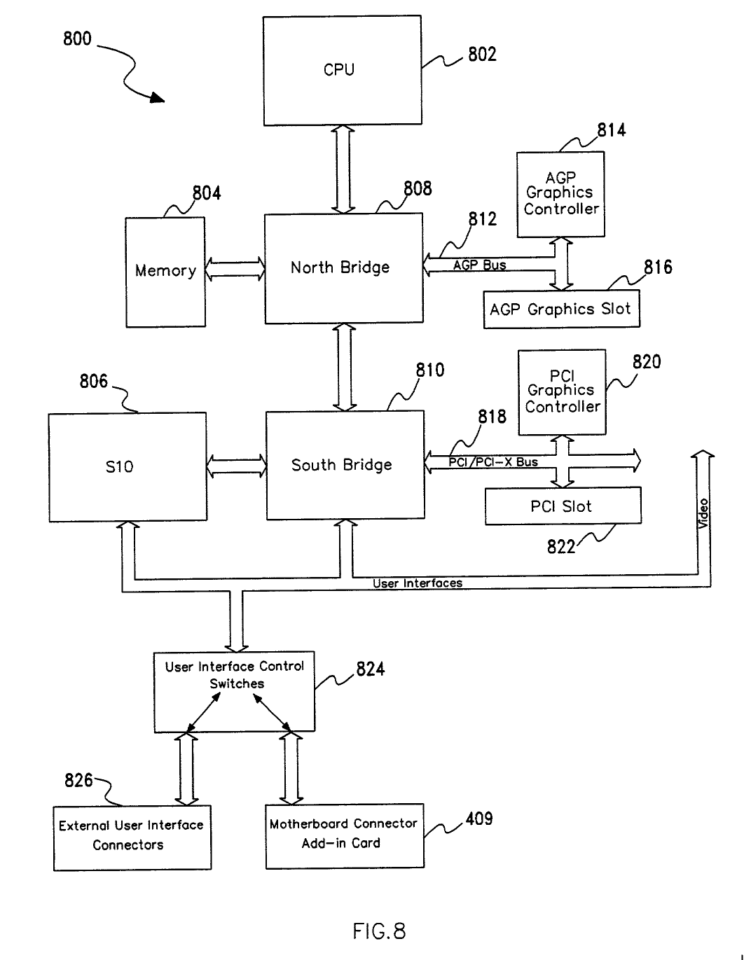

FIG. 8 is a block diagram of a host computer system motherboard configuration 800 according to principles of the present invention. A processor (CPU) 802, memory 804, and super I/O (SIO) 806 are illustrated to show motherboard communications across a north bridge 808 and a south bridge 810. The north bridge 808 provides an AGP bus 812 for AGP communications with either an AGP graphics controller 814 on the motherboard 800 or an AGP graphics slot 816 with an AGP graphics card (not shown) inserted. The AGP graphics card is a card such as the add-in card 404 with a graphic controller (e.g., graphic controller 604) compatible with AGP graphics communications.

The south bridge 810 provides a PCI/PCI-X bus 818 for PCI/PCI-X communications with either a PCI graphics controller 820 on the motherboard 800 or a PCI slot 822 with a PCI graphics card (not shown) inserted. The PCI graphics card is a card such as the add-in card 404 with a graphic controller (e.g. graphic controller 604) configured for PCI graphics communications.

The north bridge 808/south bridge 810 configuration allows one graphic controller to be enabled at a time. For example, if the north bridge 808 supports the AGP graphics controller 814, then there will be no other graphic controller. Alternatively, if the south bridge 810 supports the PCI graphics controller 820, then no other graphic controller is operational on the motherboard 800. Of note, the PCI slot 822 is representative of many slots that support PCI cards in general, not just a PCI graphics controller card. In other words, the add-in card 404 could have a PCI graphics controller and be inserted into the PCI slot 822 while other PCI cards are inserted into other PCI slots to communicate with the south bridge 810. Alternatively, the north bridge 808 may have an AGP graphics controller installed (either directly on the motherboard 800 or inserted in the AGP graphics slot 816) and non-graphic PCI communications may occur on the south bridge 810.

Significantly, as discussed above, the add-in card 404 has a motherboard header 406 for connecting directly to the motherboard connector 409. A user interface control 824 manages communications among the motherboard 800, the motherboard connector 409, and external user interface connections 826.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. A computer interface extension configuration comprising:
a host having a motherboard with a first connector that allows motherboard signals to be shared internal to the host, the motherboard also having at least a second connector separate from the first connector that supports communications with the host;
an extension transmitter card disposed within the host and being electrically coupled to the motherboard of the host via at least the first connector and the second connector, the extension transmitter card having a graphics controller that interfaces with the second connector independent from communications that occur on the first connector; and
an extension receiver coupled to a plurality of user interface devices, the extension receiver being extensibly connected to the extension transmitter card and that at least receives data transmissions from the extension transmitter card of the host to thereby provide the data transmissions to one or more of the plurality of user interface devices.

2. The computer interface extension configuration of claim 1 wherein the extension transmitter card comprises a peripheral connection interface graphics controller that communicates with the motherboard independent of communications on the first connector.

3. The computer interface extension configuration of claim 1 wherein the extension transmitter card comprises an accelerated graphics port controller that communicates with the motherboard independent of communications on the first connector.

4. The computer interface extension configuration of claim 1 wherein the plurality of user interface devices comprise a keyboard, a mouse, a video monitor, a speaker, a serial link, a USB link, a power button, and a microphone.

5. The computer interface extension configuration of claim 1 wherein the extension receiver is extensibly connected to the extension transmitter via a fiber optic cable.

6. The computer interface extension configuration of claim 1 wherein the extension receiver is extensibly connected to the extension transmitter via a cable compatible with any version of category five or above type cables.

7. The computer interface extension configuration of claim 1 wherein the extension transmitter card disposed within the host is electrically coupled to the first connector of the motherboard of the host via a ribbon cable connector disposed between the motherboard and the extension transmitter card.

8. The computer interface extension configuration of claim 1 wherein the extension transmitter card disposed within the host is electrically coupled to the second connector of the motherboard of the host via one of a PCI, PCI-X, or AGP interface with the extension transmitter card.

9. A computer interface extension transmitter comprising:
a host computer system having a motherboard with at least a first connector and a second connector that is separate from the first connector;
an extension transmitter card electrically coupled to the second connector of the motherboard, the extension transmitter card having a graphics controller and a motherboard header, the motherboard header being electrically coupled to the first connector of the host computer system, the graphics controller of the extension transmitter card defining an interface for communications between the extension transmitter card and the second connector of the host; and
an extension receiver connected to the extension transmitter card and coupled to at least one user interface device.

10. The computer interface extension transmitter of claim 9 wherein the second connector disposed on the motherboard for electrically coupling the extension transmitter card to the motherboard operates according to a graphics communication standard taken from the group consisting of a PCI interface, a PCI-X interface, and an AGP interface.

11. The computer interface extension transmitter of claim 9 wherein the first connector disposed on the motherboard separately from the second connector comprises audio communications with the extension receiver that pass through the extension transmitter card.

12. The computer interface extension transmitter of claim 9 wherein the first connector disposed on the motherboard separately from the second connector comprises analog video communications with the extension receiver that pass through the extension transmitter card.

13. The computer interface extension transmitter of claim 9 wherein the first connector disposed on the motherboard separately from the second connector comprises digital video communications with the extension receiver that pass through the extension transmitter card.

14. The computer interface extension transmitter of claim 9 wherein the graphics controller of the extension transmitter card is PCI compatible.

15. The computer interface extension transmitter of claim 9 wherein the graphics controller of the extension transmitter card is AGP compatible.

16. A method for extending computer interface communications between a host computer and a plurality of computer interface devices comprising:
electrically connecting an extension transmitter card to a slot in the host computer system, the extension transmitter card having a graphics controller compatible with the slot in the host computer;
enumerating the extension transmitter card with the host computer system such that the extension transmitter card is recognized by the host;
electrically connecting a motherboard header of the extension transmitter card to a connector on the host that is separate from the slot in the host with which the extension transmitter card is electrically connected; and
transmitting communications from the extension transmitter card to an extension receiver to complete operations with at least one of the plurality of computer interface devices.

17. The method of claim 16 wherein said transmitting communications from the extension transmitter card comprises transmitting PCI compatible graphics communications.

18. The method of claim 16 wherein said transmitting communications from the extension transmitter card comprises transmitting AGP compatible graphics communications.
